(19) United States
(12) Patent Application Publication
(10) Pub. No.: US 2018/0137877 A1
(43) Pub. Date: May 17, 2018

(54) METHOD, DEVICE AND SYSTEM FOR NOISE SUPPRESSION

(71) Applicant: GRG Banking Equipment Co., Ltd., Guangzhou, Guangdong (CN)

(72) Inventors: Gaofeng Du, Guangzhou, Guangdong (CN); Tiancai Liang, Guangzhou, Guangdong (CN); Jianping Liu, Guangzhou, Guangdong (CN); Xiaofeng Jin, Guangzhou, Guangdong (CN)

(73) Assignee: GRG Banking Equipment Co., Ltd., Guangzhou, Guangdong (CN)

(21) Appl. No.: 15/574,193

(22) PCT Filed: May 24, 2016
(86) PCT No.: PCT/CN2016/083084

§ 371 Date: Nov. 15, 2017

(30) Foreign Application Priority Data
Jun. 9, 2015 (CN) 201510312269.8

(51) Int. Cl. G10L 21/0232; G10L 25/30; G10K 11/178; G10L 25/21

(52) U.S. Cl. CPC G10L 21/0232; G10L 25/30; G10K 2210/3038; G10L 25/21; G10K 11/17821

(57) ABSTRACT

A noise suppressing method, a noise suppressing device and a noise suppressing system are provided. The noise suppressing method includes: receiving internal noise acquired by a reference voice acquisition mechanism and a voice signal containing external noise acquired by a primary voice acquisition mechanism, when the voice signal is inputted; extracting an internal signal feature corresponding to the internal noise, where the internal signal feature is a power spectrum frame sequence; acquiring an external approximate feature corresponding to the external noise based on the internal signal feature and a pre-set mapping formula; converting the external approximate feature into a noise signal estimate by the inverse Fourier transform; and performing a pre-set noise cancellation process on the noise signal estimate and the acquired voice signal containing the internal noise, to obtain a noise-suppressed de-noised voice signal.

The application claims the priority to Chinese Patent Application No. 201510312269.8, titled “METHOD, DEVICE AND SYSTEM FOR NOISE SUPPRESSION”, filed on Jun. 9, 2015 with the State Intellectual Property Office of the People's Republic of China, which is incorporated herein by reference in its entirety.

### TECHNICAL FIELD

The present disclosure relates to the technology of voice signal processing, and in particular to a noise suppressing method, a noise suppressing device and a noise suppressing system.

### BACKGROUND

Devices with a voice interaction function normally include many mechanical components, which produce a large amount of rapidly changing non-steady machine noise and impact noise during operation. The noise enters into a system through a pickup on the device, which seriously affects the voice interaction. The traditional method for suppressing noise based on noise power spectrum estimation has a poor effect on filtering the large amount of rapidly changing non-steady machine noise and impact noise. In the conventional technology, a dual-microphone noise suppressing device is often used for filtering ambient noise. The device includes a primary microphone for receiving ambient noise and voice, and a reference microphone for receiving ambient noise. Then noise is suppressed using the two signals by a known active noise cancellation (ANC) method. However, the ANC method requires that the noise is received by the primary microphone and the reference microphone from substantially the same sound field, so that noise signals received by the primary microphone and the reference microphone are in a highly linear relation. In this condition, the ANC method works properly, while if this condition is not met, the dual-microphone noise suppressing method often does not work properly. In fact, a device often has a relatively closed housing. The noise reference microphone is installed in the housing to receive machine noise, while the main microphone is generally installed in the external or at an opening on the housing in order to receive a voice. In this case, the sound fields of the reference microphone and the main microphone is quite different, resulting in a poor performance or fails of the ANC method.

Therefore, it is desired to solve the above technical problem of poor performance of the ANC method due to the great difference between the sound fields of the reference microphone and the primary microphone.

### SUMMARY

A method, a device and a noise suppressing system are provided according to embodiments of the present disclosure, to solve the technical problem of poor performance of the ANC method due to the great difference between the sound fields of the reference microphone and the primary microphone.

A noise suppressing method is provided according to an embodiment of the present disclosure, which includes:

S1, receiving, by a noise suppressing device, internal noise acquired by a reference voice acquisition mechanism and a voice signal containing external noise acquired by a primary voice acquisition mechanism, when the voice signal is inputted;

S2, extracting an internal signal feature corresponding to the internal noise, where the internal signal feature is a power spectrum frame sequence;

S3, acquiring an external approximate feature corresponding to the external noise based on the internal signal feature and a pre-set mapping formula, where the external approximate feature is a sequence of frames in a power spectrum form;

S4, converting the external approximate feature into a noise signal estimate by the inverse Fourier transform; and

S5, performing a pre-set noise cancellation process on the noise signal estimate and the acquired voice signal containing the internal noise, to obtain a noise-suppressed de-noised voice signal.

Preferably, before step S1, the method further includes:

training, under a condition that no voice signal is inputted, a preset auto-encoding neural network structure with noise signal samples composed of the internal noise and the external noise, to determine the mapping formula.

Preferably, the training a auto-encoding neural network structure includes:

S6, performing the Fourier transform on each pre-set frame of each of noise signal samples, to obtain a feature and sample angle information of the sample frame, where the feature of the sample frame is in a power spectral form;

S7, determining a training sample set (x(n),o(n))ₙ₌₁^{M} by taking the feature of the sample frame as a sample input x(n) and an expected output o(n) of the preset auto-encoding neural network structure;

S8, performing the training with each training sample in the training sample set (x(n),o(n))ₙ₌₁^{M}, to determine a weight vector and an offset parameter corresponding to the training sample set (x(n),o(n))ₙ₌₁^{M}; and

S9, adding the determined weight vector and the determined offset parameter into the preset auto-encoding neural network structure, to obtain the mapping formula of the training sample set (x(n),o(n))ₙ₌₁^{M}.

Preferably, step S5 specifically includes:

performing an ANC noise cancellation process on the noise signal estimate and the acquired voice signal containing the internal noise, to obtain the noise-suppressed de-noised voice signal.

Preferably, the preset auto-encoding neural network structure is a 5-layer structure, a first layer and a fifth layer are input and output layers, and a second layer, a third layer and a fourth layer are hidden layers.

A noise suppressing device is provided according to an embodiment of the present disclosure, which includes:

a receiving unit, configured to receive internal noise acquired by a reference voice acquisition mechanism and a voice signal containing external noise acquired by a primary voice acquisition mechanism, when the voice signal is inputted;

an extracting unit, configured to extract an internal signal feature corresponding to the internal noise, where the internal signal feature is a power spectrum frame sequence;

an acquiring unit, configured to acquire an external approximate feature corresponding to the external noise based on the internal signal feature and a pre-set mapping formula, where the external approximate feature is a sequence of frames in a power spectrum form;

a converting unit, configured to convert the external approximate feature into a noise signal estimate by the inverse Fourier transform; and

a de-noising unit, configured to perform a pre-set noise cancellation process on the noise signal estimate and the acquired voice signal containing the internal noise, to obtain a noise-suppressed de-noised voice signal.

Preferably, the noise suppressing device further includes:

a training unit, configured to train, under a condition that no voice signal is inputted, a preset auto-encoding neural network structure with noise signal samples composed of the internal noise and the external noise, to determine the mapping formula.

Preferably, the training unit specifically includes:

a converting subunit, configured to perform, under a condition that no voice signal is inputted, the Fourier transform on each pre-set frame of each of noise signal samples, to obtain a feature and sample angle information of the sample frame, where the feature of the sample frame is in a power spectral form;

a first determining subunit, configured to determine a training sample set (x(n),o(n))ₙ₌₁^{M} by taking the feature of the sample frame as a sample input x(n) and an expected output o(n) of the preset auto-encoding neural network structure;

a second determining subunit, configured to perform the training with each training sample in the training sample set (x(n),o(n))ₙ₌₁^{M}, to determine a weight vector and an offset parameter corresponding to the training sample set (x(n),o(n))ₙ₌₁^{M}; and

a calculating subunit, configured to adding the determined weight vector and the determined offset parameter into the preset auto-encoding neural network structure, to obtain the mapping formula of the training sample set (x(n),o(n))ₙ₌₁^{M}.

A noise suppressing system is provided according to an embodiment of the present disclosure, which includes:

a reference voice acquisition mechanism, a primary voice acquisition mechanism and the noise suppressing device according to any embodiments of the present disclosure.

The reference voice acquisition mechanism and the primary voice acquisition mechanism respectively are in signal transmission connection with the noise suppressing device.

The reference voice acquisition mechanism is configured to acquire an internal noise signal.

The noise suppressing device is configured to receive internal noise and a voice signal containing external noise when the voice signal is inputted, extract an internal signal feature corresponding to the internal noise, acquire an external approximate feature corresponding to the external noise based on the internal signal feature and a pre-set mapping formula, convert the external approximate feature into a noise signal estimate by the inverse Fourier transform, and perform a pre-set noise cancellation process on the noise signal estimate and the acquired voice signal containing the internal noise, to obtain a noise-suppressed de-noised voice signal.

The primary voice acquisition mechanism is configured to acquire the voice signal containing the internal noise.

The internal signal feature is a power spectrum frame sequence, and the external approximate feature is a sequence of frames in a power spectrum form.

Preferably, the primary voice acquisition mechanism is further configured to acquire the external noise under a condition that no voice signal is inputted, so that the noise suppressing device trains, under a condition that no voice signal is inputted, a preset auto-encoding neural network structure with noise signal samples composed of the internal noise and the external noise, to determine the mapping formula.

As can be seen from the above technical solution, the embodiments of the present disclosure have the following advantages.

A method, a device and a noise suppressing system are provided according to embodiments of the present disclosure. The noise suppressing method includes: S1, receiving, by the noise suppressing device, internal noise acquired by a reference voice acquisition mechanism and a voice signal containing external noise acquired by a primary voice acquisition mechanism, when the voice signal is inputted; S2, extracting an internal signal feature corresponding to the internal noise, where the internal signal feature is a power spectrum frame sequence; S3, acquiring an external approximate feature corresponding to the external noise based on the internal signal feature and a pre-set mapping formula, where the external approximate feature is a sequence of frames in a power spectrum form; S4, converting the external approximate feature into a noise signal estimate by the inverse Fourier transform; and S5, performing a pre-set noise cancellation process on the noise signal estimate and the acquired voice signal containing the internal noise, to obtain a noise-suppressed de-noised voice signal. In the embodiments, the internal signal feature corresponding to the internal noise is extracted, the external approximate feature corresponding to the external noise is acquired based on the internal signal feature and the pre-set mapping formula, the external approximate feature is converted into a noise signal estimate, and the noise cancellation process is performed using the noise signal estimate and the voice signal, thereby avoiding the restriction of great difference between external sound fields, and solving the technical problem of poor performance of the ANC method due to the great difference between the sound fields of the reference microphone and the primary microphone.

### BRIEF DESCRIPTION OF THE DRAWINGS

The accompanying drawings for the description of the embodiments or the conventional technology are described briefly as follows, so that the technical solutions according to the embodiments in the present disclosure or the conventional technology become clearer. It is apparent that the accompanying drawings in the following description are only some embodiments of the present disclosure. For those skilled in the art, other accompanying drawings may be obtained according to these accompanying drawings without any creative work.

FIG. 1 is a flow chart of a noise suppressing method according to an embodiment of the present disclosure;

FIG. 2 is a flow chart of a noise suppressing method according to another embodiment of the present disclosure;

FIG. 3 is a schematic structural diagram of a noise suppressing device according to an embodiment of the present disclosure;

FIG. 4 is a schematic structural diagram of a noise suppressing device according to another embodiment of the present disclosure;

FIG. 5 is a schematic structural diagram of a noise suppressing system according to an embodiment of the present disclosure; and

FIG. 6 is a schematic diagram of auto-coded neural network connection of a noise suppressing system according to an embodiment of the present disclosure.

### DETAILED DESCRIPTION OF THE EMBODIMENTS

A noise suppressing method, a noise suppressing device and a noise suppressing system are provided according to embodiments of the present disclosure, to solve the technical problem of poor performance of the ANC method due to the great difference between the sound fields of the reference microphone and the primary microphone.

The technical solution according to the embodiments of the present disclosure will be described clearly and completely as follows in conjunction with the accompany drawings in the embodiments of the present disclosure, so that purposes, characteristics and advantages of the present disclosure can be more clear and understandable. It is obvious that the described embodiments are only a part of the embodiments according to the present disclosure. All the other embodiments obtained by those skilled in the art based on the embodiments in the present disclosure without any creative work belong to the scope of the present disclosure.

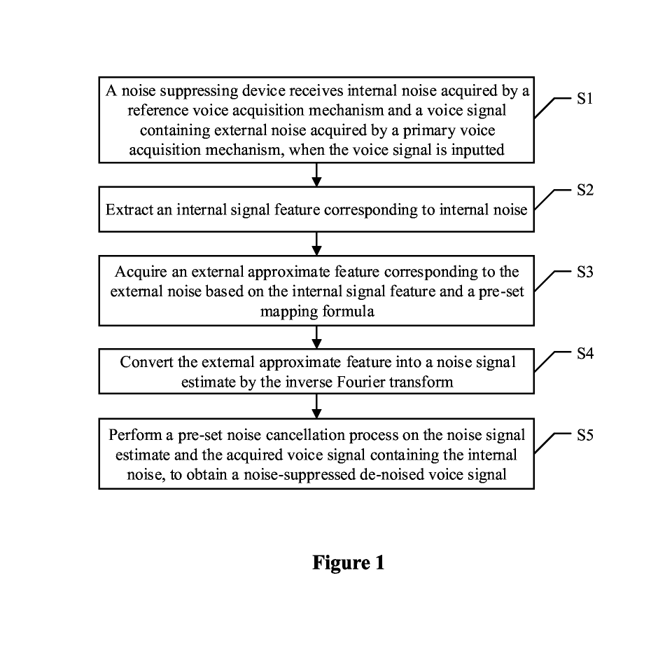

Referring to FIG. 1, a noise suppressing method according to an embodiment of the present disclosure includes steps S1 to S5.

In step S1, when a voice signal is inputted, a noise suppressing device receives internal noise acquired by a reference voice acquisition mechanism and the voice signal containing external noise acquired by a primary voice acquisition mechanism.

When it is required to de-noise the voice signal, the noise suppressing device receives the internal noise acquired by the reference voice acquisition mechanism and the voice signal containing the external noise acquired by the primary voice acquisition mechanism when the voice signal is inputted.

In step S2, an internal signal feature corresponding to the internal noise is extracted.

After receiving the internal noise acquired by the reference voice acquisition mechanism and the voice signal containing the external noise acquired by the primary voice acquisition mechanism, the noise suppressing device extracts the internal signal feature corresponding to the internal noise. The internal signal feature is a power frame spectrum sequence.

In step S3, based on the internal signal feature and a pre-set mapping formula, an external approximate feature corresponding to the external noise is acquired.

After the internal signal feature corresponding to the internal noise is extracted, the external approximate feature corresponding to the external noise is acquired based on the internal signal feature and the pre-set mapping formula. The external approximate feature is a sequence of frames in a power spectrum form.

In step S4, the external approximate feature is converted into a noise signal estimate by the inverse Fourier transform.

After the external approximate feature corresponding to the external noise is acquired based on the internal signal feature and the pre-set mapping formula, the external approximate feature is converted into the corresponding noise signal estimate by the inverse Fourier transform.

In step S5, a pre-set noise cancellation process is performed on the noise signal estimate and the acquired voice signal containing the internal noise, to obtain a noise-suppressed de-noised voice signal.

After the external approximate feature is converted into the corresponding noise signal estimate by the inverse Fourier transform, the pre-set noise cancellation process is performed on the noise signal estimate and the acquired voice signal containing the internal noise, to obtain the noise-suppressed de-noised voice signal.

In the embodiment, the internal signal feature corresponding to the internal noise is extracted, the external approximate feature corresponding to the external noise is acquired based on the internal signal feature and the pre-set mapping formula, the external approximate feature is converted into the noise signal estimate, and the noise cancellation process is performed with the noise signal estimate and the voice signal, thereby avoiding the restriction of great difference between external sound fields, and solving the technical problem of poor performance of the ANC method due to the great difference between the sound fields of the reference microphone and the primary microphone.

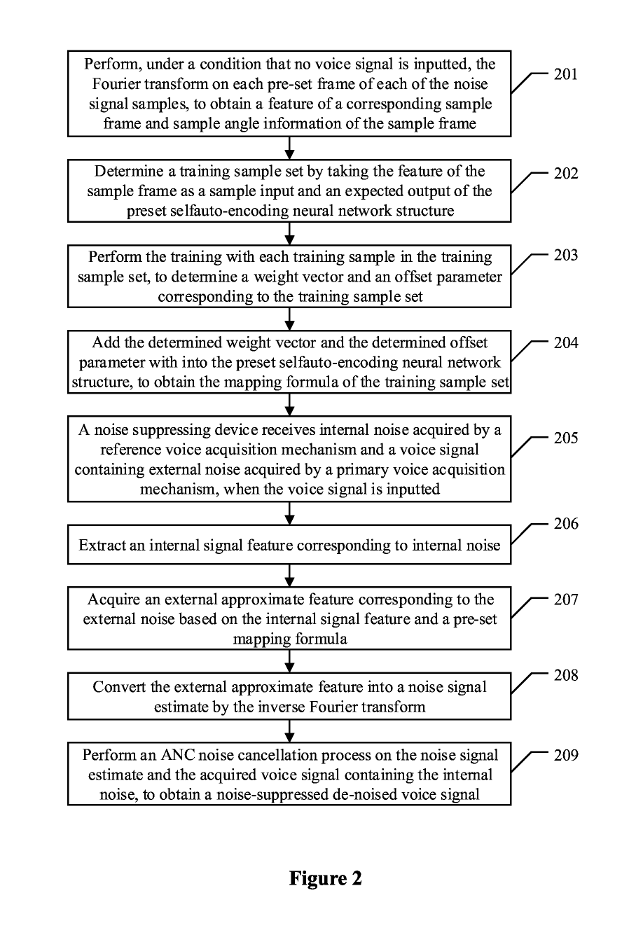

The noise suppressing method is described above in detail, and the training of the auto-encoding neural network structure is described below in detail. Referring to FIG. 2, a noise suppressing method according to another embodiment of the present disclosure includes steps 201 to 209.

In step 201, under a condition that no voice signal is inputted, the Fourier transform is performed on each pre-set frames of an acquired noise signal sample, to obtain a feature and sample angle information of the sample frame.

Before de-noising a voice signal, a preset auto-encoding neural network structure is trained with noise signal samples composed of internal noise and external noise under a condition that no voice signal is inputted, to determine a mapping formula. The above-described preset auto-encoding neural network structure may be obtained by performing the Fourier transform on each pre-set frame of the acquired noise signal sample under a condition that no voice signal is inputted, to obtain the feature of the corresponding sample frame and the sample angle information.

For example, before receiving a voice signal, both the reference voice acquisition mechanism (such as a reference microphone) and the primary voice acquisition mechanism (such as a primary microphone) collect internal machine noise and machine noise leaked to the external respectively for more than 100 hours, to form the noise signal samples. The device may be equipped with a noise suppressing device, such as a remote smart teller. The acquired noise signal samples are sampled at the frequency of 8 kHz, then a windowing process is performed on the noise signal samples with a Hamming window of 32 ms, to obtain a sequence of frames. Each of the frames has 256 sampling points. Then the Fourier transform is performed on each of frames of the noise signal samples. A power spectrum S(ω) and an angle angle(ω) of the noise signal sample are obtained by getting the square of the transformed Fourier coefficients. The power spectrum S(ω) is used as an internal feature, and the angle angle(ω) is used for converting the internal feature back to the signal.

In step 202, by taking the feature of the sample frame as a sample input x(n) and an expected output o(n) of the auto-encoding neural network structure, a training sample set (x(n),o(n))ₙ₌₁^{M} is determined.

After the Fourier transform is performed on each pre-set frame of the acquired noise signal sample to obtain the feature of the corresponding sample frame and the sample angle information, a training sample set (x(n),o(n))ₙ₌₁^{M} is determined by taking the feature of the sample frame as a sample input x(n) and an expected output o(n) of the preset auto-encoding neural network structure. For example, 5 successive frames of the logarithmic power spectrum S(ω) of each internal feature of the noise signals received by the reference microphone and the main microphone are taken as the internal feature of the voice signal and as an input and an expected output of the auto-encoding neural network, and all the 5-frame signal features extracted from the primary microphone signals and the reference microphone signals constitute a training sample set (x(n),o(n))ₙ₌₁^{M}, which is used in step 203.

In step 203, the training is performed with each training sample in the training sample set (x(n),o(n))ₙ₌₁^{M}, to determine a weight vector and an offset parameter corresponding to the training sample set (x(n),o(n))ₙ₌₁^{M}.

After the training sample set (x(n),o(n))ₙ₌₁^{M} is determined by taking the feature of the sample frame as the sample input x(n) and the expected output o(n) of the preset auto-encoding neural network structure, the training is performed with each training sample in the training sample set (x(n),o(n))ₙ₌₁^{M}, to determine the weight vector and the offset parameter corresponding to the training sample set (x(n),o(n))ₙ₌₁^{M}.

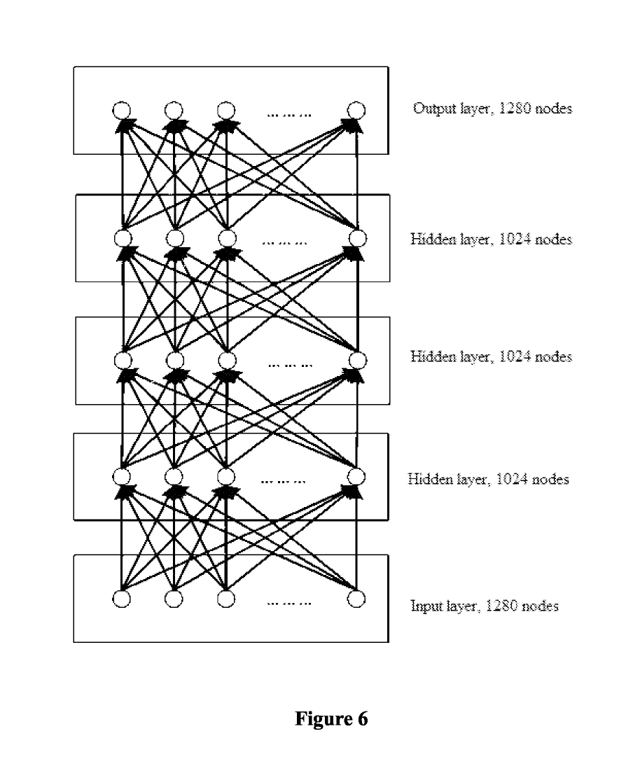

For example, the preset auto-encoding neural network structure is a 5-layer structure. A first layer and a fifth layer are input and output layers, each having 1280 nodes, which is the number of dimensions of the 5 frame signal feature. A second layer, a third layer and a fourth layer are hidden layers, each having 1024 nodes. A larger number of hidden layers and a larger number of nodes lead to more accurate mapping of the network, while also lead to a larger amount of computation and a larger number of required samples. It should be noted that, the number of hidden layers and the number of nodes per layer are determined by making a trade-off. The network is a fully connected network. x(n) is used as a network input, and o(n) is used as a expected network output. It is noted that the above neural network structure may be as shown in FIG. 6.

For a n^{th} training sample, an input is a vector x(n), an expected output is o(n), and a neuron output vector of the input layer is.

A final result of the training is to calculate a weight wₗ, l=2, 3, 4, 5 and an offset parameter bₗl=2, 3, 4, 5 of the auto-coding neural network based on the input and expected output sample set (x(n),o(n))ₙ₌₁^{M}.

The network training process is described as follows.

A) An initial weight value wₗ, l=2, 3, 4, 5 is randomly selected according to the auto-coded neural network structure, and the offset value bₗl=2, 3, 4, 5 is set to zero. A first sample in the training sample set is taken, where n=1.

B) According to a formula y₁ (n)=x(n), the input vector x(n) is mapped to the neuron output vector y₁(n) of the input layer.

C) According to a mapping relation calculation formula, a neuron output vector of the input layer is mapped to a neuron output vector of a first hidden layer, the neuron output vector of the first hidden layer is mapped to a neuron output vector of a second hidden layer, the neuron output vector of the second hidden layer is mapped to a neuron output vector of a third hidden layer, and the neuron output vector of the third hidden layer is mapped to a neuron output vector of the output layer.

The mapping relation calculation formula is expressed as:

yᵢ(n)=σ(uₗ(n)),

u₁(n)=wₗyₗ₋₁(n)+bₗl=2,3,4,5.

Where,

$$σ ( n ) = \frac{1}{1 + {e}^{- x}} ,$$

e is a base of a natural logarithm, w₁ is a weight vector of a first layer, b₁ is an offset coefficient. When l=2, the formula is used for mapping the neuron output vector of the input layer into a neuron output vector of a first hidden layer. When l=3, 4, the formulas are used for mapping the neuron output vector of the first hidden layer into the neuron output vector of the second hidden layer, and mapping the neuron output vector of the second hidden layer into the neuron output vector of the third hidden layer. When l=5, the formula is used for mapping the neuron output vector of the third hidden layer into the neuron output vector of the output layer.

D) According to a vector of the output layer and the expected output vector o(n), an error function (which is a function for measuring accuracy of outputs of the network) is calculated with a formula E(n)=0.5×∥y₅(n)−o(n)∥₂².

E) According to a derivative calculation formula, derivatives of the error function with respect to the weight and offset of each layer are calculated.

The derivative calculation formula is:

$$\frac{\partial E}{\partial {w}_{l}} = {{x}^{l - 1} ( {δ}^{l} )}^{T} , \\ \frac{\partial E}{\partial {w}_{l}} = {δ}^{l} , l = 5 , 4 , 3 , 2.$$

For the hidden layer, we have δ^{l}=(wₗ₊₁)^{T}·δ^{l+1} σ^{l+1}(uₗ), l=2, 3, 4, and for the output layer, we have l=5, δ⁵=σ′(u₅)·(y₅(n)−o(n)).

F) Based on the derivatives of the error function with respect to the weight and offset of each layer, new weights and offsets are calculated with the calculation formula as:

wₗ^{new}=wₗ+Δwₗ,

bₗ^{new}=bₗ+Δbₗ,l=5,4,3,2.

In the calculation formula,

$$Δ {w}_{l} = - η \frac{\partial E}{\partial {w}_{l}} , Δ {b}_{l} = - η \frac{\partial E}{\partial {b}_{l}} ,$$

l=5, 4, 3, 2 are variations of the weights and offsets, and η is a learning rate. A large η leads to oscillation of the new weights and offsets, while a small η leads to a slow learning. According to the present disclosure, η=0.05 is determined by making a trade-off.

G) The new weights and offsets are set as the weights and offsets of the auto-coding neural network, which are expressed as follows:

wₗ=wₗ^{new}l,=2,3,4,5,

bₗ=bₗ^{new}l,=2,3,4,5,

H) If the variation of each weight vector and each offset parameter (Δwₗ, l=2, 3, 4, 5, Δbₗ, l=2, 3, 4, 5, see the calculation formulas in F) is less than a given threshold Th, the training ends. Otherwise, a next sample is taken, i.e., n=n+1, and the process turns to step 202, to perform to the next round of training. A large threshold Th leads to inadequate training, while a small threshold Th leads to a long time of training. In the present disclosure, Th=0.001 is determined by making a trade-off.

In step 204, the determined weight vector and the determined offset parameter are added into the preset auto-encoding neural network structure, to obtain the mapping formula of the training sample set (x(n),o(n))ₙ₌₁^{M}.

After the training is performed with each training sample in the training sample set (x(n),o(n))ₙ₌₁^{M} to determine the weight vector and the offset parameter corresponding to the training sample set (x(n),o(n))ₙ₌₁^{M}, the determined weight vector and the determined offset parameter are added into the preset auto-encoding neural network structure, to obtain the mapping formula of the training sample set (x(n),o(n))ₙ₌₁^{M}.

A result of adding the weight and the offset data into the neural network structure is the mapping relationship between the internal noise signal feature and the external noise signal feature. The mapping formula is expressed as:

σ=σ(w₅σ(w₄σ(w₃σ(w₂x+b₂)+b₃)+b₄)+b₅).

In step 205, when the voice signal is inputted, a noise suppressing device receives internal noise acquired by a reference voice acquisition mechanism and a voice signal containing external noise acquired by a primary voice acquisition mechanism.

When the voice signal is inputted, the noise suppressing device receives the internal noise acquired by the reference voice acquisition mechanism and the voice signal containing external noise acquired by the primary voice acquisition mechanism.

It is to be noted that, when the above device operates, the reference microphone acquires the internal mechanical noise, and the main microphone acquires the voice signal containing the mechanical noise. According to step 202, a feature is extracted from the noise signal acquired by the reference microphone, to obtain the information of power spectrum frame sequence and angle sequence.

In step 206, an internal signal feature corresponding to the internal noise is extracted.

After receiving the internal noise acquired by the reference voice acquisition mechanism and the voice signal containing the external noise acquired by the primary voice acquisition mechanism, the noise suppressing device extracts the internal signal feature corresponding to the internal noise. The internal signal feature is a power spectrum frame sequence.

For example, an internal feature of successive 5 frame signal is inputted to the trained auto-encoding neural network. According to the mapping formula obtained in step 203, the network output is the external approximation feature of the noise signal received by the main microphone.

In step 207, based on the internal signal feature and a pre-set mapping formula, an external approximate feature corresponding to the external noise is acquired.

After the internal signal feature corresponding to the internal noise is extracted, the external approximate feature corresponding to the external noise is acquired based on the internal signal feature and the pre-set mapping formula. The external approximate feature is a sequence of frames in a power spectrum form.

For example, the inverse Fourier transform is performed on the auto-encoding neural network output noise signal estimation with the corresponding frame angle, to obtain the estimated noise signal \hat{x}(n).

In step 208, the external approximate feature is converted into a noise signal estimate by the inverse Fourier transform.

After the external approximate feature corresponding to the external noise is acquired based on the internal signal feature and the pre-set mapping formula, the external approximate feature is converted into the corresponding noise signal estimate by the inverse Fourier transform.

In step 209, the ANC noise cancellation process is performed on the noise signal estimate and the acquired voice signal containing the internal noise, to obtain a noise-suppressed de-noised voice signal.

After the external approximate feature is converted into the corresponding noise signal estimate by the inverse Fourier transform, the ANC noise cancellation process is performed on the noise signal estimate and the acquired voice signal containing the internal noise, to obtain the noise-suppressed de-noised voice signal.

The above ANC noise cancellation processing is described as follows.

A vector composed of noise signal estimate at the first m time points received by a primary microphone at time n is denoted as X=(\hat{x}(n),\hat{x}(n−1), . . . , \hat{x}(n−m))^{T}, a voice signal containing mechanical noise collected by the primary microphone at time n is denoted as d(n), and W=(w(1), w(2), . . . , w(m))^{T} is a weighting coefficient of a filter, where T represents a transposition of a vector. A large m leads to a large amount of computation, while a small m leads to a poor effect of noise suppression. In the embodiment, m=32.

a) An initial weight value W of weighting coefficient of the filter is selected at random at an initial time n=1.

b) Based on a formula ŝ(n)=d(n)−W^{T} X, the noise-suppressed voice signal ŝ(n) for the time n is calculated.

c) Based on a formula W^{new}=W+2μ(d(n)−W^{T} X)X, a new weighting coefficient W^{new} of the filter is calculated. A parameter μ is a learning factor of the weighting coefficient. A large or small μ will leads to a poor effect of noise suppression. In the embodiment, μ=0.05.

d) The new weighting coefficient W^{new} is set as the weighting coefficient of the filter, that is, W=W^{new}.

e) A noise signal estimate and a voice signal containing mechanical noise at the next time point are taken, where n=n+1, and the process turns to step b).

The ŝ(n) is calculated for each time point using the ANC method, to serve as a noise-suppressed voice signal outputted by the ANC method for the time point.

In the embodiment, the internal signal feature corresponding to the internal noise is extracted, the external approximate feature corresponding to the external noise is acquired based on the internal signal feature and the pre-set mapping formula, the external approximate feature is converted into the noise signal estimate, and the noise cancellation process is performed on the noise signal estimate and the voice signal, thereby avoiding the restriction of great difference between external sound fields, and solving the technical problem of poor performance of the ANC method due to the great difference between the sound fields of the reference microphone and the primary microphone. Furthermore, the combination of neural network and the ANC method greatly improves the de-noising effect of the voice signal.

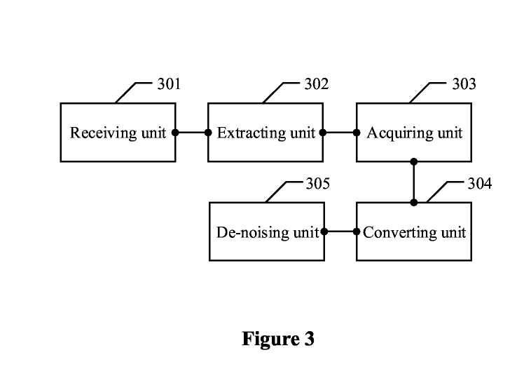

Referring to FIG. 3, a noise suppressing device provided according to an embodiment of the present disclosure includes: a receiving unit 301, an extracting unit 302, an acquiring unit 303, a converting unit 304 and a de-noising unit 305.

The receiving unit 301 is configured to receive internal noise acquired by a reference voice acquisition mechanism and a voice signal containing external noise acquired by a primary voice acquisition mechanism, when the voice signal is inputted.

The extracting unit 302 is configured to extract an internal signal feature corresponding to the internal noise. And the internal signal feature is a power spectrum frame sequence.

The acquiring unit 303 is configured to acquire an external approximate feature corresponding to the external noise based on the internal signal feature and a pre-set mapping formula. And the external approximate feature is a sequence of frames in a power spectrum form.

The converting unit 304 is configured to convert the external approximate feature into a noise signal estimate by the inverse Fourier transform.

The de-noising unit 305 is configured to perform a pre-set noise cancellation process on the noise signal estimate and the acquired voice signal containing the internal noise, to obtain a noise-suppressed de-noised voice signal.

In the embodiment, the extracting unit 302 extracts the internal signal feature corresponding to the internal noise, the acquiring unit 303 acquires the external approximate feature corresponding to the external noise based on the internal signal feature and the pre-set mapping formula, and the de-noising unit 305 performs the noise cancellation process on the voice signal and the noise signal estimate converted from the external approximate feature, thereby avoiding the restriction of great difference between external sound fields, and solving the technical problem of poor performance of the ANC method due to the great difference between the sound fields of the reference microphone and the primary microphone.

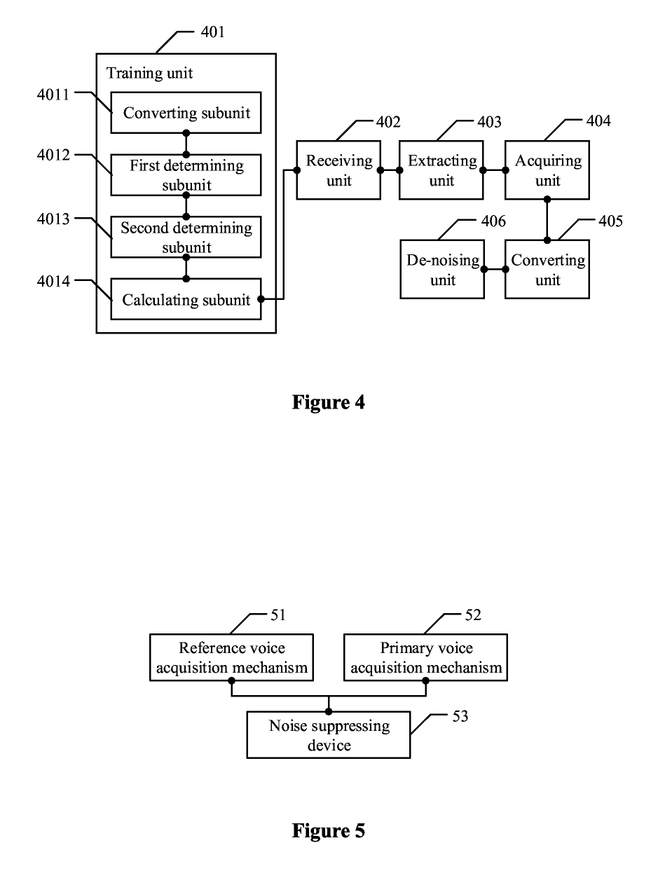

Units of the noise suppressing device are described above in detail, and additional units will be described in detail below. Referring to FIG. 4, the noise suppressing device according to another embodiment of the present disclosure includes: a training unit 401, a receiving unit 402, an extracting unit 403, an acquiring unit 404, a converting unit 405 and a de-noising unit 406.

The training unit 401 is configured to train, under a condition that no voice signal is inputted, a preset auto-encoding neural network structure with noise signal samples composed of the internal noise and the external noise, to determine the mapping formula.

The training unit 401 includes: a converting subunit 4011, a first determining subunit 4012, a second determining subunit 4013, and a calculating subunit 4014.

The converting subunit 4011 is configured to perform, under a condition that no voice signal is inputted, the Fourier transform on each pre-set frame of each of noise signal samples, to obtain a feature and sample angle information of the sample frame. The feature of the sample frame is in a power spectral form.

The first determining subunit 4012 is configured to determine a training sample set (x(n),o(n))ₙ₌₁^{M} by taking the feature of the sample frame as a sample input x(n) and an expected output o(n) of the preset auto-encoding neural network structure.

The second determining subunit 4013 is configured to perform the training with each training sample in the training sample set (x(n),o(n))ₙ₌₁^{M}, to determine a weight vector and an offset parameter corresponding to the training sample set (x(n),o(n))ₙ₌₁^{M}.

The calculating subunit 4014 is configured to add the determined weight vector and the determined offset parameter into the preset auto-encoding neural network structure, to obtain the mapping formula of the training sample set (x(n),o(n))ₙ₌₁^{M}.

The receiving unit 402 is configured to receive internal noise acquired by a reference voice acquisition mechanism and a voice signal containing external noise acquired by a primary voice acquisition mechanism, when the voice signal is inputted.

The extracting unit 403 is configured to extract an internal signal feature corresponding to the internal noise. The internal signal feature is a power spectrum frame sequence.

The acquiring unit 404 is configured to acquire an external approximate feature corresponding to the external noise based on the internal signal feature and a pre-set mapping formula. The external approximate feature is a sequence of frames in a power spectrum form.

The converting unit 405 is configured to convert the external approximate feature into a noise signal estimate by the inverse Fourier transform.

The de-noising unit 406 is configured to perform a pre-set noise cancellation process on the noise signal estimate and the acquired voice signal containing the internal noise, to obtain a noise-suppressed de-noised voice signal.

In the embodiment, the extracting unit 403 extracts the internal signal feature corresponding to the internal noise, the acquiring unit 404 acquires the external approximate feature corresponding to the external noise based on the internal signal feature and the pre-set mapping formula, and the external approximate feature is converted into a noise signal estimate, and the de-noising unit 406 performs the noise cancellation process with the voice signal and the estimated noise signal converted from the external approximate feature, thereby avoiding the restriction of great difference between external sound fields, and solving the technical problem of poor performance of the ANC method due to the great difference between the sound fields of the reference microphone and the primary microphone.

Furthermore, the combination of neural network and the ANC method greatly improves the de-noising effect of the voice signal.

Referring to FIG. 5, a noise suppressing system according to an embodiment of the present disclosure includes: a reference voice acquisition mechanism 51, a primary voice acquisition mechanism 52 and the noise suppressing device 53 in the embodiments as shown in FIG. 3 and FIG. 4.

The reference voice acquisition mechanism 51 and the primary voice acquisition mechanism 52 are in signal transmission connection with the noise suppressing device 53.

The reference voice acquisition mechanism 51 is configured to acquire an internal noise signal, such as an internal noise signal of a remote smart teller.

The noise suppressing device 53 is configured to receive internal noise and a voice signal containing external noise when the voice signal is inputted, extract an internal signal feature corresponding to the internal noise, acquire an external approximate feature corresponding to the external noise based on the internal signal feature and a pre-set mapping formula, convert the external approximate feature into a noise signal estimate by the inverse Fourier transform, and perform a pre-set noise cancellation process on the noise signal estimate and the acquired voice signal containing the internal noise, to obtain a noise-suppressed de-noised voice signal.

The primary voice acquisition mechanism 52 is configured to acquire the voice signal containing the internal noise. The primary voice acquisition mechanism 52 is further configured to acquire the external noise under a condition that no voice signal is inputted, so that the noise suppressing device 53 trains, under a condition that no voice signal is inputted, a preset auto-encoding neural network structure with noise signal samples composed of the internal noise and the external noise, to determine the mapping formula.

The internal signal feature is a power spectrum frame sequence, and the external approximate feature is a sequence of frames in a power spectrum form.

Further, the reference voice acquisition mechanism 51 and the primary voice acquisition mechanism 52 may be microphones, which is not limited herein.

It is to be known clearly by those skilled in the art that, for convenient and clear description, for specific operation of the above system, device and unit, reference may be made to the corresponding process in the above method embodiment, which is not repeated here.

In the embodiments mentioned in the disclosure, it is to be understood that, the disclosed system, device and method may be implemented in other ways. For example, the above device embodiment is only illustrative. For example, the division of the units is only a logical functional division. In practice, there may be other divisions. For example, multiple units or assembles may be combined or may be integrated into another system. Alternatively, some features may be neglected or not be performed. The displayed or discussed mutual coupling or direct coupling or communication connection may be an indirect coupling or communication connection via some interfaces, devices or units, which may be in an electrical, mechanical or other form.

The units described as separate components may be or may not be separate physical units, and a component which is displayed as a unit may be or may not be a physical unit, that is, may be located at a same position, or may be distributed over multiple network units. Some or all of the units may be selected as required to implement the solution of the embodiment.

Further, the functional units in the embodiments of the disclosure may be integrated into one processing unit, or may be implemented as separate physical units. One or more units may be integrated into one unit. The above integrated unit may be implemented in hardware, or may be implemented as a software functional unit.

When being implemented as a software functional unit and being sold and used as a separate product, the integrated unit may be stored in a computer readable storage medium. Based on this, essential part or a part contributing to the prior art of the technical solution of the disclosure or the whole or part of the technical solution may be embodied as a software product which is stored in a storage medium, including several instructions for causing a computer device (which may be a personal computer, a server, a network device or the like) to perform all or some of the steps of the method in the embodiment of the disclosure. The storage medium includes various mediums capable of storing program code, such as a U disk, a movable disk, a Read-Only Memory (ROM), a Random Access Memory (RAM), a magnetic disk or an optical disk.

As described above, the above embodiments are only intended to describe the technical solutions of the disclosure, but not to limit the scope of the disclosure. Although the disclosure is described in detail with reference to the above embodiments, it should be understood by those skilled in the art that modifications can be made to the technical solutions in the above embodiments or equivalents can be made to some or all of the technical features thereof. Those modifications and equivalents will not make the corresponding technical solutions deviate from the scope of the technical solutions of the embodiments of the disclosure.

1. A noise suppressing method, comprising:
S1, receiving, by a noise suppressing device, internal noise acquired by a reference voice acquisition mechanism and a voice signal containing external noise acquired by a primary voice acquisition mechanism, when the voice signal is inputted;
S2, extracting an internal signal feature corresponding to the internal noise, wherein the internal signal feature is a power spectrum frame sequence;
S3, acquiring an external approximate feature corresponding to the external noise based on the internal signal feature and a pre-set mapping formula, wherein the external approximate feature is a sequence of frames in a power spectrum form;
S4, converting the external approximate feature into a noise signal estimate by the inverse Fourier transform; and
S5, performing a pre-set noise cancellation process on the noise signal estimate and the acquired voice signal containing the internal noise, to obtain a noise-suppressed de-noised voice signal.

2. The noise suppressing method according to claim 1, wherein before step S1, the method further comprises:
training, under a condition that no voice signal is inputted, a preset auto-encoding neural network structure with noise signal samples composed of the internal noise and the external noise, to determine the mapping formula.

3. The noise suppressing method according to claim 2, wherein training the auto-encoding neural network structure comprises:
S6, performing the Fourier transform on each pre-set frame of each of noise signal samples, to obtain a feature and sample angle information of the sample frame, wherein the feature of the sample frame is in a power spectral form;
S7, determining a training sample set (x(n),o(n))ₙ₌₁^{M} by taking the feature of the sample frame as a sample input x(n) and an expected output o(n) of the preset auto-encoding neural network structure;
S8, performing the training with each training sample in the training sample set (x(n),o(n))ₙ₌₁^{M}, to determine a weight vector and an offset parameter corresponding to the training sample set (x(n),o(n))ₙ₌₁^{M}; and
S9, adding the determined weight vector and the determined offset parameter into the preset auto-encoding neural network structure, to obtain the mapping formula of the training sample (x(n),o(n))ₙ₌₁^{M}.

4. The noise suppressing method according to claim 1, wherein step S5 comprises:
performing an ANC noise cancellation process on the noise signal estimate and the acquired voice signal containing the internal noise, to obtain the noise-suppressed de-noised voice signal.

5. The noise suppressing method according to claim 2, wherein the preset auto-encoding neural network structure is a 5-layer structure, a first layer and a fifth layer are input and output layers, and a second layer, a third layer and a fourth layer are hidden layers.

6. A noise suppressing device, comprises:
a receiving unit, configured to receive internal noise acquired by a reference voice acquisition mechanism and a voice signal containing external noise acquired by a primary voice acquisition mechanism, when the voice signal is inputted;
an extracting unit, configured to extract an internal signal feature corresponding to the internal noise, wherein the internal signal feature is a power spectrum frame sequence;
an acquiring unit, configured to acquire an external approximate feature corresponding to the external noise based on the internal signal feature and a pre-set mapping formula, wherein the external approximate feature is a sequence of frames in a power spectrum form;
a converting unit, configured to convert the external approximate feature into a noise signal estimate by the inverse Fourier transform; and
a de-noising unit, configured to perform a pre-set noise cancellation process on the noise signal estimate and the acquired voice signal containing the internal noise, to obtain a noise-suppressed de-noised voice signal.

7. The noise suppressing device according to claim 6, wherein the noise suppressing device further comprises:
a training unit, configured to train, under a condition that no voice signal is inputted, a preset auto-encoding neural network structure with noise signal samples composed of the internal noise and the external noise, to determine the mapping formula.

8. The noise suppressing device according to claim 7, wherein the training unit comprises:
a converting subunit, configured to perform, under a condition that no voice signal is inputted, the Fourier transform on each pre-set frame of each of noise signal samples, to obtain a feature and sample angle information of the sample frame, wherein the feature of the sample frame is in a power spectral form;
a first determining subunit, configured to determine a training sample set (x(n),o(n))ₙ₌₁^{M} by taking the feature of the sample frame as a sample input x(n) and an expected output o(n) of the preset auto-encoding neural network structure;
a second determining subunit, configured to perform the training with each training sample in the training sample set (x(n),o(n))ₙ₌₁^{M}, to determine a weight vector and an offset parameter corresponding to the training sample set (x(n),o(n))ₙ₌₁^{M}; and
a calculating subunit, configured to add the determined weight vector and the determined offset parameter into the preset auto-encoding neural network structure, to obtain the mapping formula of the training sample set (x(n),o(n))ₙ₌₁^{M}.

9. A noise suppressing system, comprising:
a reference voice acquisition mechanism,
a primary voice acquisition mechanism, and
a noise suppressing device; wherein
the reference voice acquisition mechanism and the primary voice acquisition mechanism are in signal transmission connection with the noise suppressing device;
the reference voice acquisition mechanism is configured to acquire an internal noise signal;
the noise suppressing device comprises:
a receiving unit, configured to receive internal noise acquired by the reference voice acquisition mechanism and a voice signal containing external noise acquired by the primary voice acquisition mechanism, when the voice signal is inputted;
an extracting unit, configured to extract an internal signal feature corresponding to the internal noise, wherein the internal signal feature is a power spectrum frame sequence;
an acquiring unit, configured to acquire an external approximate feature corresponding to the external noise based on the internal signal feature and a pre-set mapping formula, wherein the external approximate feature is a sequence of frames in a power spectrum form;
a converting unit, configured to convert the external approximate feature into a noise signal estimate by the inverse Fourier transform; and
a de-noising unit, configured to perform a pre-set noise cancellation process on the noise signal estimate and the acquired voice signal containing the internal noise, to obtain a noise-suppressed de-noised voice signal;
the primary voice acquisition mechanism is configured to acquire the voice signal containing the internal noise; and
the internal signal feature is a power spectrum frame sequence, and the external approximate feature is a sequence of frames in a power spectrum form.

10. The noise suppressing system according to claim 9, wherein
the primary voice acquisition mechanism is further configured to acquire the external noise under a condition that no voice signal is inputted, wherein the noise suppressing device trains, under a condition that no voice signal is inputted, a preset auto-encoding neural network structure with noise signal samples composed of the internal noise and the external noise, to determine the mapping formula.

11. The noise suppressing method according to claim 2, wherein step S5 comprises:
performing an ANC noise cancellation process on the noise signal estimate and the acquired voice signal containing the internal noise, to obtain the noise-suppressed de-noised voice signal.

12. The noise suppressing method according to claim 3, wherein step S5 comprises:
performing an ANC noise cancellation process on the noise signal estimate and the acquired voice signal containing the internal noise, to obtain the noise-suppressed de-noised voice signal.

13. The noise suppressing method according to claim 3, wherein the preset auto-encoding neural network structure is a 5-layer structure, a first layer and a fifth layer are input and output layers, and a second layer, a third layer and a fourth layer are hidden layers.

14. The noise suppressing system according to claim 9, wherein the noise suppressing device further comprises:
a training unit, configured to train, under a condition that no voice signal is inputted, a preset auto-encoding neural network structure with noise signal samples composed of the internal noise and the external noise, to determine the mapping formula.

15. The noise suppressing system according to claim 14, wherein the training unit comprises:
a converting subunit, configured to perform, under a condition that no voice signal is inputted, the Fourier transform on each pre-set frame of each of noise signal samples, to obtain a feature and sample angle information of the sample frame, wherein the feature of the sample frame is in a power spectral form;
a first determining subunit, configured to determine a training sample set (x(n),o(n))ₙ₌₁^{M} by taking the feature of the sample frame as a sample input x(n) and an expected output o(n) of the preset auto-encoding neural network structure;
a second determining subunit, configured to perform the training with each training sample in the training sample set (x(n),o(n))ₙ₌₁^{M}, to determine a weight vector and an offset parameter corresponding to the training sample set (x(n),o(n))ₙ₌₁^{M}; and
a calculating subunit, configured to add the determined weight vector and the determined offset parameter into the preset auto-encoding neural network structure, to obtain the mapping formula of the training sample set (x(n),o(n))ₙ₌₁^{M}.
